(19) United States
(12) Patent Application Publication
(10) Pub. No.: US 2004/0085470 A1
(43) Pub. Date: May 6, 2004

(54) Digital camera, image capture device and captured image display control method

(75) Inventor: Mamoru Miyashita, Saitama-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/688,932

(22) Filed: Oct. 21, 2003

(30) Foreign Application Priority Data
Oct. 22, 2002 (JP) 2002-306694

(51) Int. Cl. H04N 5/222

(52) U.S. Cl. 348/333.11

(57) ABSTRACT

A digital camera capable of simplifying detailed checking of a captured image. When a release switch instructs image capture, a CCD image-captures a subject. If an ON state detection section detects continuation of an ON state of the release switch after this image capture instruction, a display control section controls such that the captured image is displayed at an LCD monitor to the extent of the duration of the ON state of the release switch. Additionally, when a zoom button or cross-key button issues an instruction relating to the image display during the ON state, size, position or the like of a display object region of the captured image, which display object region is displayed at the LCD monitor, is changed.

### CROSS-REFERENCE TO RELATED APPLICATION

This application claims priority under 35 USC 119 from Japanese Patent Application No. 2002-306694, the disclosure of which is incorporated by reference herein.

### BACKGROUND OF THE INVENTION

1. Field of the Invention

The present invention relates to a digital camera, an image capture device and a captured image display control method, and particularly to a digital camera, image capture device and captured image display control method which display a captured image at a display portion, such as an LCD or the like, immediately after image capture.

2. Description of the Related Art

Conventionally, there have been digital cameras which capture still images of subjects and record the captured images as electronic data.

At such a digital camera, a liquid crystal display (hereafter referred to as an “LCD”) may be provided for displaying captured images and the like, This digital camera may also be provided with a function for displaying a captured image for a predetermined duration immediately after image capture (a “preview image display function”). (See, for example, Japanese Patent Application (JP-A) No. 2001-197346.)

However, in a conventional digital camera, because the captured image is displayed only for the predetermined duration by the preview image display function, the display duration of the captured image cannot be altered. As a result, the preview image display finishes without regard to an amount of time that a user requires for verification and inspection. Further, in a case in which sequential image capture is desired, it is necessary to wait until the preview image display has finished before the next image capture. As a result, good opportunities for image capture may be lost.

In order to solve these problems, the provision of a function which, for the preview image display, displays the captured image on the LCD for a verification and inspection duration that is requested by the user is known.

However, even when the function for displaying the captured image on the LCD for the verification and inspection duration is provided, the captured image that is displayed on the LCD display is simply displayed as it is. Therefore, if the captured image is to be verified in detail, it is necessary to temporarily stop the display, read out the recorded image, and re-do the display.

### SUMMARY OF THE INVENTION

In consideration of the circumstances described above, an object of the present invention is to provide a digital camera, image capture device and captured image display control method which are capable of facilitating detailed verification of a captured image.

To this end, a first aspect of the present invention is to provide a digital camera including: an image capture section which captures a subject and generates a captured image; a display section which displays the captured image; an instruction section including an instruction switch, which issues an image capture instruction to the image capture section when the instruction switch is in an ON state; an input section which administers instructions relating to image display; and a control section which, if the ON state of the instruction section is continuingly detected after the image capture instruction, controls such that the captured image is displayed at the display section for as long as the ON state and which, if an instruction is issued by the input section during this ON state, controls a change of size of a display object region of the captured image that is to be displayed at the display section.

When image capture is instructed to the image capture section by the instruction switch in the ON state, an image of a subject is captured by the image capture section and displayed at the display section. Here, if the ON state of the instruction section is detected as continuing after the image capture instruction, the control section controls such that this captured image is displayed at the display section. In addition, when an instruction relating to image display is issued by the input section during the ON state of the instruction section, the control section controls the change in the size of the display object region of the captured image, which display object region is to be displayed at the display section. Accordingly, the duration for displaying the captured image after the image capture instruction can be changed in accordance with a duration for which the instruction section is set to the ON state. During this display of the captured image, the size of the display object region of the captured image can be changed, and thus detailed verification of the captured image can be facilitated.

The control section may include: a display control section which controls such that the captured image is displayed at the display section for as long as the ON state; and a region control section which, when the instruction is issued by the input section during the ON state of the instruction section, controls the change of the size of the display object region of the captured image that is to be displayed at the display section.

Because the control section includes the display control section and the region control section, and thus display control and control of changes in the size of the captured image display object region are separately implemented, loads on the apparatus can be alleviated.

The region control section may include a position control section which changes position of the display object region in accordance with an instruction from the input section.

Not only can the size of the display object region of the captured image be changed; the position of the display object region can also be changed. Thus, detailed verification of the captured image immediately after image capture is further facilitated.

The control section may include a detection section which detects the duration of continuation of the ON state.

Because the control section includes the detection section, a duration for display continuation can be simply acquired.

The instruction section may include a release switch. When the role of the instruction section is assigned to the release switch, a simplification of apparatus structure can be achieved.

A second aspect of the present invention is to provide an imaging device including: an image capture section which captures a subject and generates a captured image when an instruction for image capture is received; a display section which displays the captured image generated by the image capture section; an image display instruction section which issues an instruction for display of the captured image at the display section; a region change instruction section which issues an instruction for change of a display object region of the captured image at the display section; and a control section which, if the instruction for display of the captured image from the image display instruction section is detected subsequent to the instruction for image capture to the image capture section, controls such that the captured image is displayed at the display section for as long as the instruction for display is detected and which, if the instruction for change of the display object region from the region change instruction section is issued while the instruction for display is detected, controls so as to change the display object region of the captured image that is to be displayed at the display section in accordance with the instruction from the region change instruction section.

Here, the image capture device may further include a detection section which detects whether or not the image display instruction section is issuing the instruction for display of the captured image. Furthermore, the image display instruction section may include an image capture button which issues the instruction for image capture by the image capture section and which, after the instruction for image capture, issues the instruction for display of the captured image for as long as a state of the image capture button at the time of the instruction for image capture is maintained.

The control section may control so as to change at least one of size of the display object region of the captured image and position of the display object region in accordance with the instruction from the region change instruction section. Further, the region change instruction section may issue an instruction for change of the display object region of the captured image by selecting one or more from a plurality of pre-specified regions of the captured image.

A third aspect of the present invention is to provide a captured image display control method for an image capture device which captures a subject, generates a captured image and displays the captured image at a display section, the method including the steps of: instructing the display section to display the captured image; instructing changing of a display object region of the captured image at the display section; if the instruction to display the captured image is detected after image capture, controlling such that the captured image is displayed at the display section for as long as the instruction to display the captured image is detected; and if changing of the display object region is instructed while the instruction to display the captured image is being detected, controlling so as to change the display object region of the captured image that is to be displayed at the display section in accordance with the instruction for changing of the display object region.

Here, a step of detecting the instruction to display the captured image may be included. Further, the step of controlling so as to change the display object region may include controlling so as to change at least one of size of the display object region of the captured image and position of the display object region in accordance with the instruction for changing of the display object region.

### BRIEF DESCRIPTION OF THE DRAWINGS

FIG. 1 is a block diagram showing general structure of a digital camera relating to a present embodiment.

FIG. 2 is a sequence chart showing operation of the digital camera relating to the present embodiment at a time of image capture.

FIG. 3 is a flowchart showing switching between a through-image display and a preview image display in relation to the present embodiment.

FIG. 4 is a flowchart showing details of preview image display processing relating to the present embodiment.

FIG. 5 is transformation examples of a preview image display in the digital camera relating to the present embodiment.

### DETAILED DESCRIPTION OF THE INVENTION

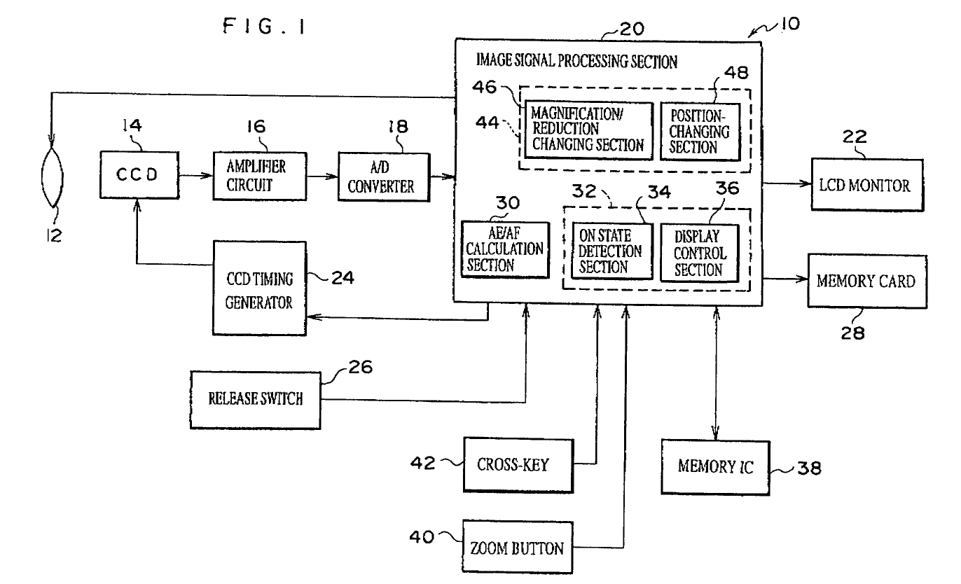

FIG. 1 shows a block diagram illustrating general structure of a digital camera 10 (below referred to simply as a “camera”) relating to a present embodiment.

The camera 10 is provided with a lens 12. The lens 12 includes functions for adjusting focusing distance of a subject and aperture value.

A solid-state imaging element CCD (below referred to simply as a “CCD”) 14 is provided in a direction of emission of light transmitted through the lens 12. The CCD 14 is capable of capturing the subject, that is, of converting light from the subject to electronic signals for obtaining a captured image. The captured image from this CCD 14 can provide captured image signals corresponding to each of R (red), G (green) and B (blue).

An amplifier circuit 16 is connected to the CCD 14. The amplifier circuit 16 amplifies captured image signals which are inputted from the CCD 14. An A/D converter 18 is connected to the amplifier circuit 16. The A/D converter 18 converts analog signals to digital signals. This A/D converter 18 converts the captured image signals that have been amplified by the amplifier circuit 16 from analog signals to digital signals.

An image signal processing section 20 is connected to the A/D converter 18. The image signal processing section 20 carries out signal processing for creating image data from the captured image signals and the like. An LCD monitor 22 is connected to the image signal processing section 20. The LCD monitor 22 displays a captured image corresponding to this image data. The image signal processing section 20 inputs the captured image signals that have been converted to digital signals by the A/D converter 18, creates the image data from the captured image signals, and outputs image data to the LCD monitor 22. A pixel count at the LCD monitor 22 is 640 by 480 pixels. At this LCD monitor 22, display of the captured image is implemented in accordance with the image data outputted from the image signal processing section 20. Note that although the camera 10 is equipped with the LCD monitor 22 in the present embodiment, the present invention is not limited thus. For example, instead of providing the LCD monitor 22 at the camera 10, an output terminal for outputting the image data to outside the camera 10 may be provided, and the captured image corresponding to the image data may be displayed at an external monitor connected to this output terminal.

Further, a CCD timing generator 24 is connected to the image signal processing section 20. The CCD timing generator 24 creates a clock signal which sets timings for operation of the CCD 14. The CCD timing generator 24 is also connected to the CCD 14. The CCD 14 determines operation timings thereof in accordance with the clock signal outputted from the CCD timing generator 24.

A release switch 26 is connected to the image signal processing section 20. The release switch 26 instructs image capture of the subject. When pressed, the release switch 26 enters an ON state, and the image signal processing section 20 controls the CCD timing generator 24 and issues an instruction for image capture to the CCD 14. A memory card 28 is also connected to the image signal processing section 20. The memory card 28 stores image data created from the captured image signals, so that this image data can be preserved. The memory card 28 is attachable to and detachable from the camera 10. When the memory card 28 is removed from the camera 10, the memory card 28 can be connected to a personal computer or to a printer to which it is possible to attach the memory card 28. Hence, manipulation of the captured image by the personal computer or printing by the printer is possible.

A memory IC 38 is further connected to the image signal processing section 20. The memory IC 38 temporarily stores image data created from the captured image signals. If the ON state of the release switch 26 is continuingly detected after the image capture instruction, the memory IC 38 can store the image data created from the captured image signals for as long as the ON state is detected.

Further still, a zoom button 40 and a cross-key button 42 are connected to the image signal processing section 20. The zoom button 40 and cross-key button 42 administer instructions relating to the image display.

The zoom button 40 is for instructing changes in the size of a display object region of the captured image. The zoom button 40 sends display object region size-changing instructions to the image signal processing section 20 for magnifying or reducing the display object region of the captured image. The camera 10 can be switched between an image capture mode and a playback mode. The image capture mode is for capturing subjects, and the playback mode is for replaying captured images for which image capture has finished at the LCD monitor 22. The display object region size-changing instructions from the zoom button 40 affect captured images in the playback mode, but also affect the captured images immediately after image capture in the image capture mode (preview images).

The cross-key button 42 acts on the captured image that is displayed at the LCD monitor 22 and is for issuing instructions for specification of the display object region, which is at least a portion of the captured image (display object region-setting instructions). The cross-key button 42 is also used for setting image capture conditions in the image capture mode, and for selecting captured images displayed at the LCD monitor 22 and the like in the playback mode. During the ON state of the release switch 26, the cross-key button 42 is used for changing a position of the display object region of the captured image, which display object region is displayed at the LCD monitor 22. The cross-key button 42 affects captured images in the playback mode, but also affects preview images in the image capture mode.

Internal sections of the image signal processing section 20 are structured to include an AE/AF calculation section 30, a preview image display control section 32, and a display object region-changing section 44. The AE/AF calculation section 30 calculates an aperture (Automatic Exposure value) and a focusing position (Automatic Focusing value) of the lens 12. The preview image display control section 32 controls such that the captured image is displayed on the LCD monitor 22 immediately after image capture in the image capture mode (preview image display). During this preview image display, the display object region-changing section 44 controls changes to the size of the display object region of the captured image that is to be displayed at the LCD monitor 22.

At the AE/AF calculation section 30, an auto-exposure value and an auto-focus value are found on the basis of captured image signals outputted from the A/D converter 18. The auto-exposure value is a result of calculation of an aperture value for the lens 12. The auto-focus value is a result of calculation of a focusing position for focusing at the subject. The lens 12 is connected to the image signal processing section 20 described above via an unillustrated motor. This motor is driven on the basis of the auto-exposure value and auto-focus value calculated in the AE/AF calculation section 30, and adjusts the aperture value and focusing position of the lens 12.

If the preview image display control section 32 detects continuation of the ON state of the release switch 26 after the image capture instruction, the preview image display control section 32 controls such that preview image display is carried out for as long as a duration of this ON state. The preview image display control section 32 is structured by an ON state detection section 34 and a display control section 36. The ON state detection section 34 detects the duration of continuation of the ON state of the release switch 26, and the display control section 36 controls for preview image display at the LCD monitor 22 during the duration of the continuation of the ON state.

An unillustrated memory is provided at the display control section 36. This unillustrated memory is capable of temporarily storing image data corresponding to captured image signals inputted from the A/D converter 18. When such image data is stored at the unillustrated memory of the display control section 36, this image data is outputted to the LCD monitor 22.

The display object region-changing section 44 receives instructions from at least one of the zoom button 40 and the cross-key button 42 during the ON state of the release switch 26 and controls changes in size and the like of the display object region of the captured image that is to be displayed at the LCD monitor 22. The display object region-changing section 44 is structured by a magnification/reduction changing section 46 and a position-changing section 48. The magnification/reduction changing section 46 changes the display object region of the captured image by magnification or reduction, and the position-changing section 48 changes the position of the display object region within the captured image.

When a display object region size-changing instruction is issued by the zoom button 40 during the ON state of the release switch 26, the magnification/reduction changing section 46 controls a change to the size of the display object region of the captured image that is displayed at the LCD monitor 22.

The position-changing section 48 changes the position of the display object region on the basis of display object region-setting instructions from the cross-key button 42 during the ON state of the release switch 26.

An unillustrated CPU is provided at the image signal processing section 20 described above. The unillustrated CPU controls driving of the unillustrated motor connected to the lens 12, operation of the CCD timing generator 24, reading and writing of image data and the like.

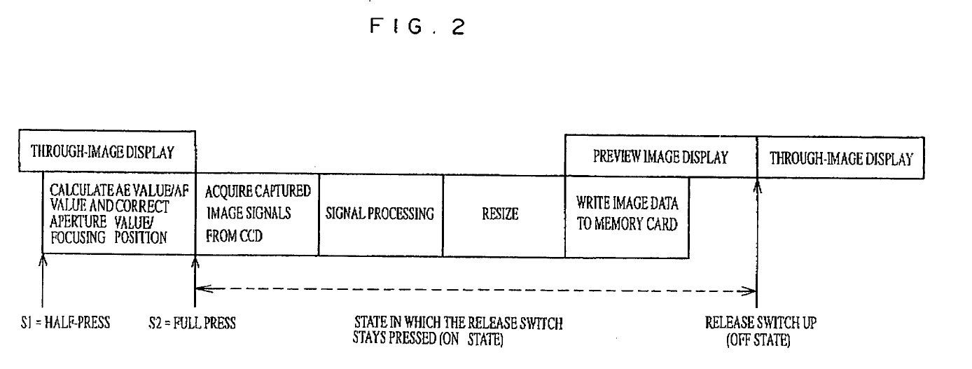

FIG. 2 shows an operation sequence of the camera 10, which is executed when the release switch 26 is pressed. In the drawing, “SI” represents a half-press of the release switch 26 and “S2” represents a full press of the release switch 26.

In a state in which capture of a subject is possible, a moving image of the subject (a through-image, that is, an image captured in real time), which is captured at the CCD 14, is displayed at the LCD monitor 22. If the release switch 26 is half-pressed and then released (to put the release switch 26 into an OFF state) while this through-image is being displayed, the AE/AF calculation section 30 operates to find an auto-exposure value and an auto-focus value. The aperture value and subject focusing position of the lens 12 are adjusted (corrected) on the basis of the thus obtained auto-exposure value and auto-focus value.

Thereafter, when the release switch 26 is fully pressed, the display of the through-image stops and the subject is captured by the CCD 14. The captured image signals are passed through the amplifier circuit 16 and the A/D converter 18 and signal-processed by the image signal processing section 20 to produce image data.

When this signal processing has been completed, on the basis of the thus created image data, the image signal processing section 20 creates image data (below referred to as “resized image data”) for which adjustment of pixel counts and the like (resizing) has been implemented as appropriate for display at the LCD monitor 22. This resized image data is transmitted to the memory IC 38. Here, the adjustment may be carried out with reference to the pixel counts of the LCD monitor 22 such that pixel counts of an image according to the resized image data are, for example, 640 by 480 pixels or 320 by 240 pixels.

When this resized image data is transmitted to the memory IC 38, the image data created from the captured image signals is transmitted to the memory card 28 by the unillustrated CPU, the resized image data is transmitted to the unillustrated memory of the display control section 36 and the captured image is displayed at the LCD monitor 22. When the image data is transmitted to the memory card 28, this image data is written to the memory card 28, and; the image data can be preserved.

While the release switch 26 is in a pressed-down state (the ON state) when the image data is being written to the memory card 28 or when writing of the image data to the memory card 28 has been completed, the preview image display is to be continued. Thus, a duration for the preview image display can be changed in accordance with the duration for which the release switch 26 is in the ON state.

When the state of the release switch 26 is changed from the pressed-down state (the ON state) to being released (the OFF state) and is returned to a state prior to pressing down of the release switch 26, the preview image display finishes and the LCD monitor 22 is returned to through-image display.

In the camera 10, if the release switch 26 exceeds a certain pre-specified amount of time in the OFF state while a power supply is on, the power supply is turned off so as to reduce electricity consumption.

Next, operation of the present embodiment will be described.

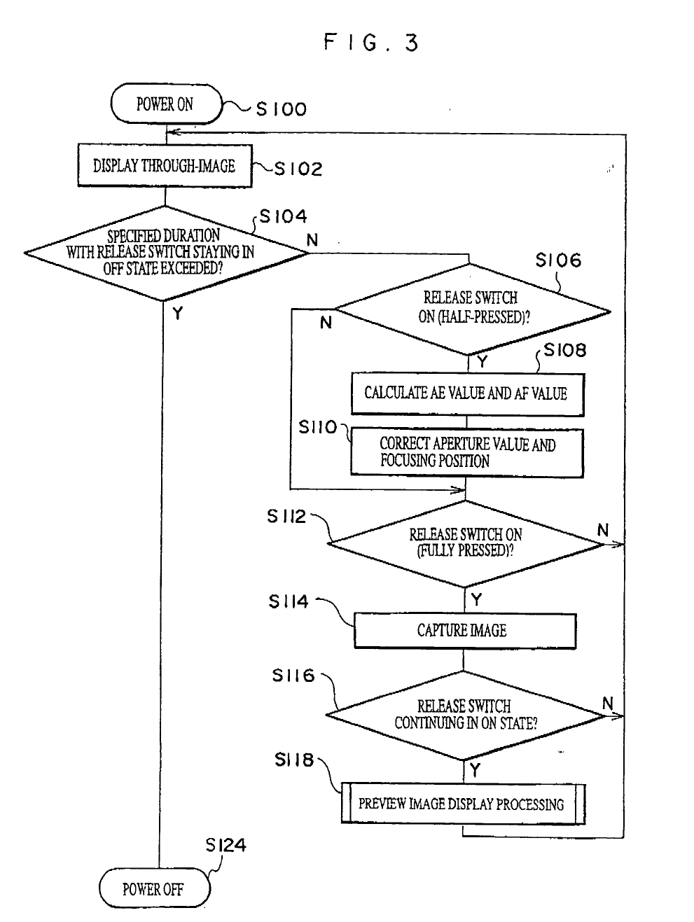

FIG. 3 shows a flowchart representing an operation for switching between through-image display and preview image display.

When the power supply of the camera 10 is turned on (step 100), the operation proceeds to step 102, the through-image is displayed at the LCD monitor 22, and the operation proceeds to step 104.

In step 104, the ON state detection section 34 detects whether or not the release switch 26 is in the ON state, and hence judges whether or not the release switch 26 has exceeded the certain amount of time continuously in a state of not being pressed down (the OFF state). If this judgement is negative, the operation proceeds to step 106, and if this judgement is positive, the operation proceeds to step 124.

In a case in which the judgement in step 104 is negative, the operation proceeds to step 106 and it is judged by the ON state detection section 34 whether or not the release switch 26 is half-pressed (the release switch 26 is ON). If this judgement is positive, the operation proceeds to step 108, and if this judgement is negative, the operation proceeds to step 112.

If the judgement instep 106 is positive, the operation proceeds to step 108, and the auto-exposure value and auto-focus value are calculated by the AE/AF calculation section 30. When the auto-exposure value and auto-focus value have been calculated, the operation proceeds to step 110. In step 110, the aperture value and subject focusing position of the lens 12 are corrected. When the aperture value and focusing position have been corrected, the operation proceeds to step 112.

If the judgement of step 106 was positive and the processing of steps 108 to 110 has been completed, or if the judgement of step 106 is negative, the operation advances to step 112, and it is judged by the ON state detection section 34 whether or not the release switch 26 is fully pressed (the release switch 26 is ON). If step 112 is negative, the operation returns to step 102, and if positive, the operation advances to step 114. In a case in which the judgement of 112 is negative, display of the through-image is to be continued.

In the subsequent step 114, the subject is captured by the CCD 14, and the image signal processing section 20 reads in the captured image signals from the CCD 14 via the amplifier circuit 16 and the A/D converter 18. At the image signal processing section 20, the image data and resized image data are created from these captured image signals. When the creation of this image data and resized image data has finished, the operation proceeds to step 116.

In step 116, it is judged by the ON state detection section 34 whether or not the release switch 26 is continuing in the ON state immediately after image capture. If this judgement is positive, the operation proceeds to step 118, and if this judgement is negative, the operation proceeds to the aforementioned step 102 and display of the through-image continues. Note that storage of the image data is possible even in cases in which this judgement is negative.

In step 118, because the release switch 26 is continuing in the ON state immediately after image capture, the display control section 36 operates to execute preview image display at the LCD monitor 22. When this preview image display has finished, the operation proceeds to the aforementioned step 102 and the through-image is displayed on the LCD monitor 22 again.

Meanwhile, if the judgement in the previously described step 104 is positive, the operation proceeds to step 124, and the electricity supply of the camera 10 is turned off in order to suppress power consumption.

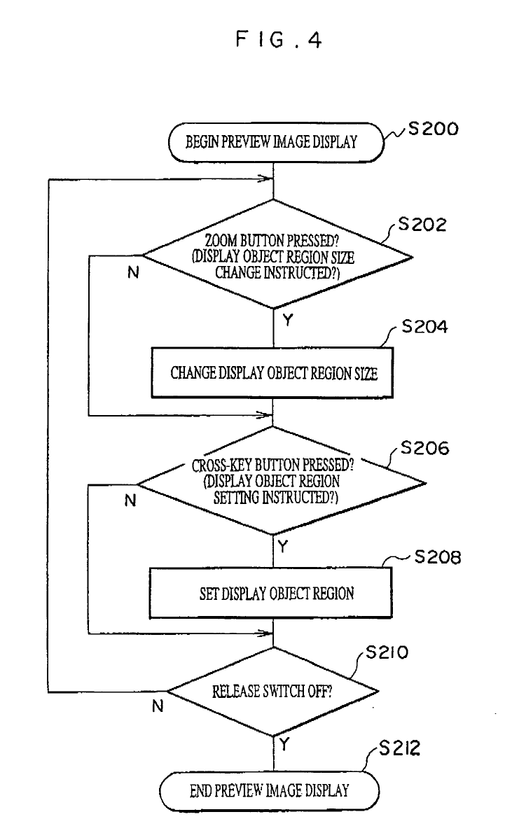

FIG. 4 shows a detailed flowchart of the preview image display processing of step 118.

When the preview image display begins (step 200), this process proceeds to step 202, and it is judged whether or not the zoom button 40 has been pressed, that is, whether or not a display object region size-changing instruction has been received. If this judgement is positive, the process proceeds to step 204, and if negative, the process proceeds to step 206.

If the judgement of step 202 is positive and the process proceeds to step 204, a change in the size of the display object region of the captured image is implemented by the magnification/reduction changing section 46. When this change in the size of the display object region has been completed, the process proceeds to step 206. Here, if the display object region is a pre-specified limit of the display object region for magnified display or limit of the display object region for reduced display (for example, the whole of the captured image (full size) or the like), the process may proceed to the subsequent step 206 without changing the size of the display object region.

If the judgement of step 202 is negative, or if the processing of step 204 has finished, the process proceeds to step 206. In step 206, it is determined whether or not the cross-key button 42 has been pressed, that is, whether or not a display object region-setting instruction has been received by the image signal processing section 20. If this judgement is positive, the process proceeds to step 208, and if negative, the process proceeds to step 210.

If the judgement of step 206 is positive and the process proceeds to step 208, in step 208, setting of the display object region of the captured image, that is, a change in the position of this display region, is implemented by the position-changing section 48. When this change of the position of the display object region has been completed, the process proceeds to step 210. Here, if the display object region is positioned at a location at a pre-specified position-changing limit (for example, an end portion of the captured image or the like), the process may proceed to the subsequent step 210 without changing the position of the display object region.

In step 210, it is judged whether or not the release switch 26 has been set to OFF. If this judgement is negative, the process returns to step 202, and if positive, the process advances to step 212 and the preview image display finishes.

In the present embodiment, the duration for which the preview image display is implemented can be changed according to whether or not the release switch 26 is in the ON state. However, the present invention is not limited thus. A preview switch for instructing implementation of the preview image display could be provided separately from the release switch 26, and the preview image display could be implemented immediately after image capture for as long as the preview switch is in an ON state thereof. Further, in either of a case in which the release switch 26 is continuously pressed and a case in which the preview switch is pressed, it may be possible to specify the preview image display by putting the corresponding switch into the ON state thereof within a predetermined amount of time after image capture.

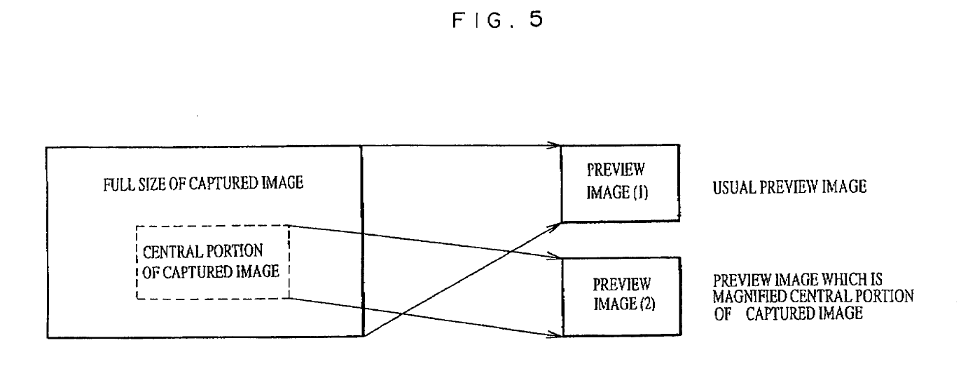

Moreover, in the present embodiment, the size, position and the like of the display object region of the captured image that is to be provided as a preview image can be changed by operations by a user. However, the present invention is not limited thus. For example, the display object region of the captured image could be changed by selecting one or more from a plurality of regions specified beforehand for the captured image. Specifically, in a case in which a memory capacity for the resized image data is limited, resized image data for a usual preview image (preview image (1), in which the whole of the captured image is the display object region) and resized image data for a preview image for which a central portion of the captured image is magnified (preview image (2), in which the central portion of the full-size captured image is the display object region) could be prepared in advance, as shown in FIG. 5, and either the preview image (1) or the preview image (2) could be displayed at the LCD monitor in accordance with operations by the user.

In the present embodiment, an example of a digital camera having only the functions of a camera has been illustrated. However, the present invention is not limited thus. Specifically, the present invention can be realized by a device which is a mobile telephone, a PDA (personal digital assistant), a personal computer or the like, and which is equipped with a camera or connected to a camera.

According to the present embodiment, when the release switch 26 is continuingly pressed down immediately after image capture (the release switch is in the ON state), the preview image display is implemented for as long as the release switch 26 is pressed down. Therefore, a duration for which the preview image display is implemented can be changed.

Further, the camera 10 changes the duration for which the captured image is displayed immediately after an image capture instruction in accordance with the duration for which the release switch 26 is set to the ON state, and can instruct changes to the size of the display object region of this captured image. Thus, detailed verification of the captured image can be made easier.

In the camera 10, the image signal processing section 20 includes the preview image display control section 32 and the display object region-changing section 44. Thus, control of changes of the size of the display object region of the captured image and display control are separately implemented. Consequently, loads on the apparatus can be alleviated.

Because the camera 10 not only changes the size of the display object region of the captured image but also changes the position of the display object region, detailed checking of the captured image immediately after image capture is made even easier.

In the camera 10, because the preview image display control section 32 includes the ON state detection section 34, a display continuation duration can be acquired with ease.

In the camera 10, the release switch 26, which is an image capture instruction section, also serves as an instruction section for implementing the preview image display. Thus, simplification of the device structure can be achieved.

According to the present invention as described above, in accordance with a duration for which an instruction section is set to an ON state, a duration for which a display object region is displayed after an image capture instruction can be changed. Additionally, a size of the display object region of this captured image can be changed for display. Thus, detailed verification of captured images can be facilitated.

What is claimed is:

1. A digital camera comprising:
an image capture section which captures a subject and generates a captured image;
a display section which displays the captured image;
an instruction section including an instruction switch, which issues an image capture instruction to the image capture section when the instruction switch is in an ON state;
an input section which administers instructions relating to image display; and
a control section which, if the ON state of the instruction section is continuingly detected after the image capture instruction, controls such that the captured image is displayed at the display section during the ON state and which, if an instruction is issued by the input section during this ON state, controls a change of size of a display object region of the captured image that is to be displayed at the display section.

2. The digital camera of claim 1, wherein the control section comprises:
a display control section which controls such that the captured image is displayed at the display section during the ON state; and
a region control section which, when the instruction is issued by the input section during the ON state of the instruction section, controls the change of the size of the display object region of the captured image that is to be displayed at the display section.

3. The digital camera of claim 2, wherein the region control section comprises a position control section which changes position of the display object region in accordance with the instruction from the input section.

4. The digital camera of claim 1, wherein the control section comprises a detection section which detects the duration of the ON state.

5. The digital camera of claim 3, wherein the control section comprises a detection section which detects the duration of the ON state.

6. The digital camera of claim 1, wherein the instruction section comprises a release switch.

7. An image capture device comprising:
an image capture section which captures a subject and generates a captured image when an instruction for image capture is received;
a display section which displays the captured image generated by the image capture section;
an image display instruction section which issues an instruction for display of the captured image at the display section;
a region change instruction section which issues an instruction for change of a display object region of the captured image at the display section; and
a control section which, if the instruction for display of the captured image from the image display instruction section is detected subsequent to the instruction for image capture to the image capture section, controls such that the captured image is displayed at the display section for as long as the instruction for display is detected and which, if the instruction for change of the display object region from the region change instruction section is issued while the instruction for display is detected, controls so as to change the display object region of the captured image that is to be displayed at the display section in accordance with the instruction from the region change instruction section.

8. The image capture device of claim 7, further comprising a detection section which detects whether or not the image display instruction section is issuing the instruction for display of the captured image.

9. The image capture device of claim 8, wherein the image display instruction section comprises an image capture button which issues the instruction for image capture by the image capture section and which, after the instruction for image capture, issues the instruction for display of the captured image for as long as a state of the image capture button at the time of the instruction for image capture is maintained.

10. The image capture device of claim 7, wherein the control section controls so as to change at least one of size of the display object region of the captured image and position of the display object region in accordance with the instruction from the region change instruction section.

11. The image capture device of claim 7, wherein the region change instruction section issues an instruction for change of the display object region of the captured image by selecting one or more from a plurality of pre-specified regions of the captured image.

12. A captured image display control method for an image capture device which captures a subject, generates a captured image and displays the captured image at a display section, the method comprising:
instructing the display section to display the captured image;
instructing changing of a display object region of the captured image at the display section;
if the instruction to display the captured image is detected after image capture, controlling such that the captured image is displayed at the display section for as long as the instruction to display the captured image is detected; and
if changing of the display object region is instructed while the instruction to display the captured image is being detected, controlling so as to change the display object region of the captured image that is to be displayed at the display section in accordance with the instruction for changing of the display object region.

13. The captured image display control method of claim 12, further comprising the step of detecting the instruction to display the captured image.

14. The captured image display control method of claim 12, wherein the step of controlling so as to change the display object region comprises controlling so as to change at least one of size of the display object region of the captured image and position of the display object region in accordance with the instruction for changing of the display object region.
